(19) United States
(12) Patent Application Publication
(10) Pub. No.: US 2026/0248083 A1
(43) Pub. Date: Aug. 27, 2026

(54) SYSTEMS AND METHODS FOR CONTROLLING WATER PRESSURE SUPPLIED WITHIN A CENTER PIVOT IRRIGATION SYSTEM

(71) Applicant: Husqvarna AB, Huskvarna (SE)

(72) Inventors: James G. Stewart, II, Kaysville, UT (US); Galin Yordanov Yordanov, Austin, TX (US); Eric James Joyce, Ankeny, IA (US)

(73) Assignee: Husqvarna AB, Huskvarna (SE)

(21) Appl. No.: 19/060,595

(22) Filed: Feb. 21, 2025

(51) Int. Cl. A01G 25/16; A01G 25/09

(52) U.S. Cl. CPC A01G 25/16; A01G 25/092

(57) ABSTRACT

A system for controlling water pressure supplied to a center pivot irrigation system is disclosed. The system may comprise non-transitory computer readable media and computer program code for formulating a set of two or more formulated sectors within a watering region of the center pivot irrigation system. A sector-specific set point pressure for each of the two or more formulated sectors may be specified. A triggering position of a pivoting span of the center pivot irrigation may also be determined. When the pivoting span reaches a triggering position for a particular formulated sector, the set point pressure of a variable frequency drive for the center pivot irrigation system is altered to the associated sector-specific set point pressure. Analogous methods and non-transitory computer readable media are also disclosed.

### TECHNICAL FIELD

The present invention relates generally to controlling water pressure. More specifically, the present invention relates to systems and methods for controlling water pressure within a center pivot irrigation system.

### BACKGROUND

The pressure supplied to a center pivot irrigation system can significantly impact the performance of such a system. For example, if insufficient pressure is supplied, water will not reach the end of the pivoting span, resulting in inadequate watering of vegetation positioned remotely relative to the pivot center. If water is supplied at too high a pressure, this could potentially damage sprinkler heads or result in excessive misting of the provided water, thereby reducing the effectiveness of the system.

In addition, not all terrain watered with a center pivot irrigation system is flat. Therefore, pressure may increase when the pivoting span reaches an area of lower elevation and decrease when the pivoting span reaches an area of higher elevation. Therefore, improved systems and methods for supplying water pressure to a pivot irrigation system are desirable.

### SUMMARY

The following is a brief overview of the subject matter at issue and is in no way limiting of that subject matter at issue.

Various embodiments of a system for controlling water pressure supplied within a center pivot irrigation system are disclosed. The center pivot irrigation system may include a pivot center, a pivoting span extending away from the pivot center, a pump for providing pressurized water to the pivot center, and a variable frequency drive that controls a speed of the pump based on a set point pressure. The pivoting span may comprise a plurality of sprinklers for distributing water, the various embodiments of the system may include non-transitory computer readable media and computer program code, encoded on the non-transitory computer readable media, configured to cause at least one processor of a set of one or more processors to perform one or more steps.

The steps of various embodiments of the system may include formulating a set of two or more formulated sectors within a watering region of the center pivot irrigation system, each of the two or more formulated sectors may comprise a start sector boundary and an end sector boundary.

The steps of various embodiments of the system may include specifying a sector-specific set point pressure for each of the two or more formulated sectors, a first sector-specific set point pressure may comprise the sector-specific set point pressure specified for a first sector of the two or more formulated sectors.

The steps of various embodiments of the system may include determining a triggering position of the pivoting span for each of the two or more formulated sectors, a first triggering position may comprise the triggering position determined for the first sector.

The steps of various embodiments of the system may include when the center pivot irrigation system is in operation: periodically ascertaining a position of the pivoting span; and altering the set point pressure of the variable frequency drive to the first sector-specific set point pressure when the pivoting span reaches the first triggering position.

Within various embodiments of the system, determining the triggering position of the pivoting span for each of the two or more formulated sectors may comprise estimating GPS coordinates of a GPS unit disposed on the pivoting span at the start sector boundary for each of the two or more formulated sectors, and periodically ascertaining the position of the pivoting span may comprise obtaining GPS coordinates from the GPS unit disposed on the pivoting span.

Within various embodiments of the system, determining the triggering position of the pivoting span for each of the two or more formulated sectors may comprise ascertaining an angular position of the start sector boundary for each of the two or more formulated sectors, and periodically ascertaining the position of the pivoting span may be performed by a central span position sensing system at the pivot center.

Within various embodiments of the system, the central span position sensing system at the pivot center may comprise a potentiometer.

Various embodiments of the system may further comprise presenting a user interface, wherein formulating the set of two or more formulated sectors within the watering region and specifying the sector-specific set point pressure for each of the two or more formulated sectors may be performed in response to user input received at the user interface.

Within various embodiments of the system, formulating the set of two or more formulated sectors within the watering region of the center pivot irrigation system may comprise one or more of the following: obtaining elevation data for the center pivot irrigation system; dividing a cultivable portion of the watering region into analytic sectors, estimating an elevation of each wheeled tower of the pivoting span using the elevation data within each analytic sector; estimating the elevation associated with the watering region using the elevation data to formulate a base elevation value; for each analytic sector, calculating a difference value by subtracting the base elevation value from the estimated elevation of a wheeled tower of highest elevation within each analytic sector; and grouping adjacent analytic sectors having the difference values within a specified threshold value, wherein each set of one or more grouped analytic sectors comprise one of the formulated sectors of the set of two or more formulated sectors.

Within various embodiments of the system, specifying the sector-specific set point pressure may comprise one or more of the following, for each analytic sector, multiplying the difference value by a multiplier to achieve a set point pressure modifier; and calculating an analytic-sector set point pressure by adding the set point pressure modifier to a base set point value associated with the watering region; and, for each of the formulated sectors formulated by grouping adjacent analytic sectors, determining a sector-specific set point pressure based on the analytic-sector set point pressures from the grouped adjacent analytic sectors associated with the formulated sector.

Various embodiments of the system may comprise at least a server and a local device.

Various embodiments of a method for controlling water pressure supplied within a center pivot irrigation system are disclosed. The center pivot irrigation system may include a pivot center, a pivoting span extending away from the pivot center, a pump for providing pressurized water to the pivot center, and a variable frequency drive that controls a speed of the pump based on a set point pressure. The pivoting span may comprise a plurality of sprinklers for distributing water. Various embodiments of the method may comprise one or more of the following steps.

Steps of the various embodiments of the method may include formulating, utilizing at least one processor of a set of one or more processors, a set of two or more formulated sectors within a watering region of the center pivot irrigation system, each of the two or more formulated sectors may comprise a start sector boundary and an end sector boundary.

Steps of the various embodiments of the method may include specifying, utilizing at least one processor of the set of one or more processors, a sector-specific set point pressure for each of the two or more formulated sectors, a first sector-specific set point pressure may comprise the sector-specific set point pressure specified for a first sector of the two or more formulated sectors.

Steps of the various embodiments of the method may include determining, utilizing at least one processor of the set of one or more processors, a triggering position of the pivoting span for each of the two or more formulated sectors, a first triggering position may comprise the triggering position determined for the first sector.

Steps of the various embodiments of the method may include when the center pivot irrigation system is in operation: periodically ascertaining, utilizing at least one processor of the set of one or more processors, a position of the pivoting span; and altering, utilizing at least one processor of the set of one or more processors, the set point pressure of the variable frequency drive to the first sector-specific set point pressure when the pivoting span reaches the first triggering position.

Within various embodiments of the method, determining the triggering position of the pivoting span for each of the two or more formulated sectors may comprise estimating GPS coordinates of a GPS unit disposed on the pivoting span at the start sector boundary for each of the two or more formulated sectors, and periodically ascertaining the position of the pivoting span may comprise obtaining GPS coordinates from the GPS unit disposed on the pivoting span.

Within various embodiments of the method, determining the triggering position of the pivoting span for each of the two or more formulated sectors may comprise ascertaining an angular position of the start sector boundary for each of the two or more formulated sectors, and periodically ascertaining the position of the pivoting span may be performed by a central span position sensing system at the pivot center.

Various embodiments of the method may further comprise presenting a user interface, wherein formulating the set of two or more formulated sectors within the watering region and specifying the sector-specific set point pressure for each of the two or more formulated sectors may be performed in response to user input received at the user interface.

Within various embodiments of the method, formulating the set of two or more formulated sectors within the watering region of the center pivot irrigation system may comprise one or more of the following: obtaining elevation data for the center pivot irrigation system; dividing a cultivable portion of the watering region into analytic sectors, estimating an elevation of each wheeled tower of the pivoting span using the elevation data within each analytic sector; estimating the elevation associated with the watering region using the elevation data to formulate a base elevation value; for each analytic sector, calculating a difference value by subtracting the base elevation value from the estimated elevation of a wheeled tower of highest elevation within each analytic sector; and grouping adjacent analytic sectors having the difference values within a specified threshold value, wherein each set of one or more grouped analytic sectors comprise one of the formulated sectors of the set of two or more formulated sectors.

Within various embodiments of the method, specifying the sector-specific set point pressure may comprise one or more of the following, for each analytic sector, multiplying the difference value by a multiplier to achieve a set point pressure modifier; and calculating an analytic-sector set point pressure by adding the set point pressure modifier to a base set point value associated with the watering region; and, for each of the formulated sectors formulated by grouping adjacent analytic sectors, determining a sector-specific set point pressure based on the analytic-sector set point pressures from the grouped adjacent analytic sectors associated with the formulated sector.

Various embodiments of a computer program product for controlling water pressure supplied within a center pivot irrigation system are disclosed. The center pivot irrigation system may include a pivot center, a pivoting span extending away from the pivot center, a pump for providing pressurized water to the pivot center, and a variable frequency drive that controls a speed of the pump based on a set point pressure. The pivoting span may comprise a plurality of sprinklers for distributing water. The computer program product may comprise non-transitory computer readable media; and computer program code, encoded on the non-transitory computer readable media, configured to cause at least one processor of a set of one or more processors to perform one or more steps.

The one or more steps implemented via the computer program product may include formulating a set of two or more formulated sectors within a watering region of the center pivot irrigation system, each of the two or more formulated sectors may comprise a start sector boundary and an end sector boundary.

The one or more steps implemented via the computer program product may include specifying a sector-specific set point pressure for each of the two or more formulated sectors, a first sector-specific set point pressure may comprise the sector-specific set point pressure specified for a first sector of the two or more formulated sectors.

The one or more steps implemented via the computer program product may include determining a triggering position of the pivoting span for each of the two or more formulated sectors, a first triggering position may comprise the triggering position determined for the first sector.

The one or more steps may include when the center pivot irrigation system is in operation: periodically ascertaining a position of the pivoting span; and altering the set point pressure of the variable frequency drive to the first sector-specific set point pressure when the pivoting span reaches the first triggering position.

Within various embodiments of the computer program product, determining the triggering position of the pivoting span for each of the two or more formulated sectors may comprise estimating GPS coordinates of a GPS unit disposed on the pivoting span at the start sector boundary for each of the two or more formulated sectors, and periodically ascertaining the position of the pivoting span may comprise obtaining GPS coordinates from the GPS unit disposed on the pivoting span.

Within various embodiments of the computer program product, determining the triggering position of the pivoting span for each of the two or more formulated sectors may comprise ascertaining an angular position of the start sector boundary for each of the two or more formulated sectors, and periodically ascertaining the position of the pivoting span may be performed by a central span position sensing system at the pivot center.

Within various embodiments of the computer program product, formulating the set of two or more formulated sectors within the watering region of the center pivot irrigation system may comprise one or more of the following: obtaining elevation data for the center pivot irrigation system; dividing a cultivable portion of the watering region into analytic sectors, estimating an elevation of each wheeled tower of the pivoting span using the elevation data within each analytic sector; estimating the elevation associated with the watering region using the elevation data to formulate a base elevation value; for each analytic sector, calculating a difference value by subtracting the base elevation value from the estimated elevation of a wheeled tower of highest elevation within each analytic sector; and grouping adjacent analytic sectors having the difference values within a specified threshold value, wherein each set of one or more grouped analytic sectors comprise one of the formulated sectors of the set of two or more formulated sectors.

Within various embodiments of the computer program product, specifying the sector-specific set point pressure may comprise: for each analytic sector: multiplying the difference value by a multiplier to achieve a set point pressure modifier; and calculating an analytic-sector set point pressure by adding the set point pressure modifier to a base set point value associated with the watering region; and, for each of the formulated sectors formulated by grouping adjacent analytic sectors, determining a sector-specific set point pressure based on the analytic-sector set point pressures from the grouped adjacent analytic sectors associated with the formulated sector.

### BRIEF DESCRIPTION OF THE DRAWINGS

Illustrative embodiments of the invention will become more fully apparent from the following description and appended claims, taken in conjunction with the accompanying drawings. Understanding that these drawings depict only illustrative embodiments and are, therefore, not to be considered limiting of the invention's scope, the illustrative embodiments of the invention will be described with additional specificity and detail through use of the accompanying drawings in which:

FIG. 1 is a diagram illustrating one embodiment of a center pivot irrigation system;

FIG. 2A is a diagram illustrating a watering region of a center pivot irrigation system having four formulated sectors, and FIG. 2B is a table illustrating a start sector boundary, an end sector boundary, and a sector-specific set point pressure for each of the formulated sectors of FIG. 2A;

FIG. 3A is a diagram illustrating a watering region of a center pivot irrigation system having three formulated sectors, and FIG. 3B is a table illustrating a start sector boundary, an end sector boundary, and a sector-specific set point pressure for each of the formulated sectors of FIG. 3A;

FIG. 4 illustrates a user interface for specifying start sector boundaries, end sector boundaries, and sector-specific set point pressures.

FIG. 5 is a flow diagram illustrating a method of formulating sectors and specifying sector-specific set point pressures and operating a center pivot irrigation system in accordance with the formulated sectors and the specified sector-specific set point pressures;

FIG. 6 is a diagram of obtained elevation data at various points on watering region of a center pivot irrigation system;

FIG. 7 is a table illustrating methods of formulating sectors and specifying sector-specific set point pressures for each of the formulated sectors based on the obtained elevation data of FIG. 6;

FIG. 8 is a diagram illustrating the formulated sectors in accordance with the table of FIG. 7;

FIG. 9 is a flow diagram illustrating one method of formulating sectors based on obtained elevation data;

FIG. 10 is a flow diagram illustrating a method of formulating sector-specific set point pressures for formulated sectors based on obtained elevation data; and

FIG. 11 is a block diagram illustrating one embodiment of a controller.

### DETAILED DESCRIPTION

Various aspects of the present disclosure are described below. It should be apparent that the teachings herein may be embodied in a wide variety of forms and that any specific structure, function, or both disclosed herein is merely representative. Based on the teachings herein, one skilled in the art should appreciate that an aspect disclosed herein may be implemented independently of any other aspects and that two or more of these aspects may be combined in various ways, even if that combination is not specifically illustrated in the figures or description. For example, an apparatus may be implemented, or a method may be practiced, using any number of the aspects set forth herein whether disclosed in connection with a method or an apparatus. Further, the disclosed apparatuses and methods may be practiced using structures or functionality known to one of skill in the art at the time this application was filed, although not specifically disclosed within the application.

### Definitions and Terminology

This section provides introductory definitions for terms used in this application. Additional definitions may appear within the context of specific figure discussions. The term “exemplary,” as used herein, denotes an example, implementation, or aspect of the disclosed subject matter without indicating preference for any particular implementation.

Ordinal terms such as “first” or “second” are provided for identification and ease of reference. They do not necessarily imply physical characteristics or ordering unless explicitly stated. Therefore, this terminology distinguishes elements with similar names, such as “first element” and “second element,” rather than indicating priority or sequence.

Indefinite articles like “a” and “an” signify “one or more” rather than “one.”

When describing a structure or operation that “comprises” or “includes” an element, additional elements not explicitly mentioned may also be included. Therefore, the terms “including,” “comprising,” and “having” should be understood as “including but not limited to” unless expressly stated otherwise. Similarly, an operation described as occurring “based on” a condition or event may also depend on other conditions or events not explicitly mentioned.

The terms “an embodiment,” “one embodiment,” or “another embodiment” do not refer to a single variation of the disclosed subject matter. Instead, they indicate that multiple variations may be applied to different implementations.

A “set” may include one or more of each item coming within the specified “set.” Therefore, unless otherwise explicitly specified a set may include a single item or a plurality of items.

An enumerated list of items in connection with an embodiment does not imply exclusivity or inclusivity unless specifically stated otherwise.

### Relationship and Attachment Terminology

The phrases “secured to,” “connected to,” “coupled to,” and “in communication with” refer to any interaction between entities, including mechanical, electrical, magnetic, electromagnetic, or thermal interactions, as well as fluid communication. “Attached to” refers to mechanical coupling that restricts relative translation or rotation, while “pivotally attached to” and “slidably attached to” allow relative rotation or translation, respectively.

The phrase “attached directly to” indicates attachment with direct contact or separation by a single fastener, adhesive, or similar mechanism. The term “abut” denotes items in direct physical contact, whether attached, fused, or welded.

“Integrally formed” describes items manufactured as a single piece without requiring assembly. Conversely, “separately manufactured” indicates items that are not integrally formed, whether by different processes, or at different times, or locations.

### Alignment and Positioning Terminology

The term “substantially coaxially aligned” indicates that two items share a common imaginary axis or are within 15° of sharing a common imaginary axis. The items may be spaced apart along this axis.

The term “offset and substantially coaxially aligned” refers to items sharing a common imaginary axis, with their center points spaced apart along this common imaginary axis.

“Overlapping and substantially coaxially aligned” refers to items that overlap along a common imaginary axis while remaining aligned.

“Coextensive and substantially coaxially aligned” describes items sharing a common axis and extending over the same distance along the axis.

“Center point nonalignment” signifies that the center points of each of the two identified items are not aligned along a designated axis.

“Center point alignment” signifies that the center points of each of the two identified items are aligned at least one designated axis or prospective (e.g., from a top view or a side view).

“Outer boundary nonalignment” refers to items whose outer boundaries are not aligned along a designated axis. “Nonaligned positions” indicates that two items are not aligned along at least one axis, covering both center point and outer boundary nonalignment.

The term “generally” indicates an orientation or value within 10° of the specified angle, while “substantially” indicates a value within 10% of the specified value. Therefore, for example, “generally parallel” indicates components are within 10° of being perfectly parallel, and “generally perpendicular” indicates that the identified components are within 10° of being perfectly perpendicular.

### REFERENCE NUMERALS IN THE FIGURES

While certain components may appear multiple times in a drawing, not all instances will be labeled to preserve the clarity of the figures. Descriptions will clarify which specific instances are referenced, even if not explicitly labeled in the figures.

### Grouping of Figures

Based on the headings provided below, certain figures will be discussed as a group. The part names and reference numerals discussed in such a group will not necessarily appear in all of the figures in the group but will appear in at least one figure within the group.

### Introduction

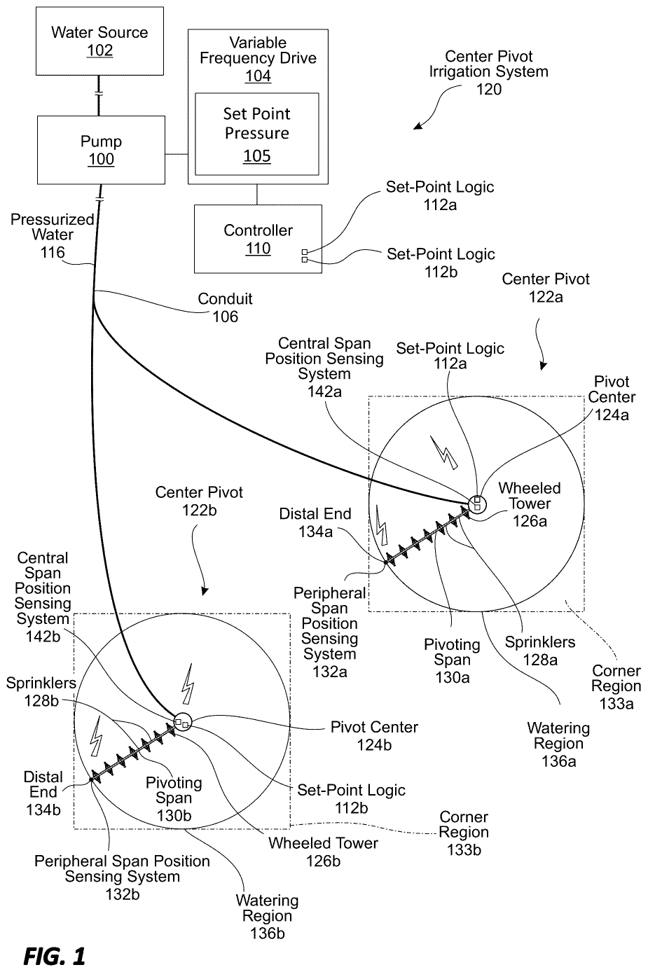

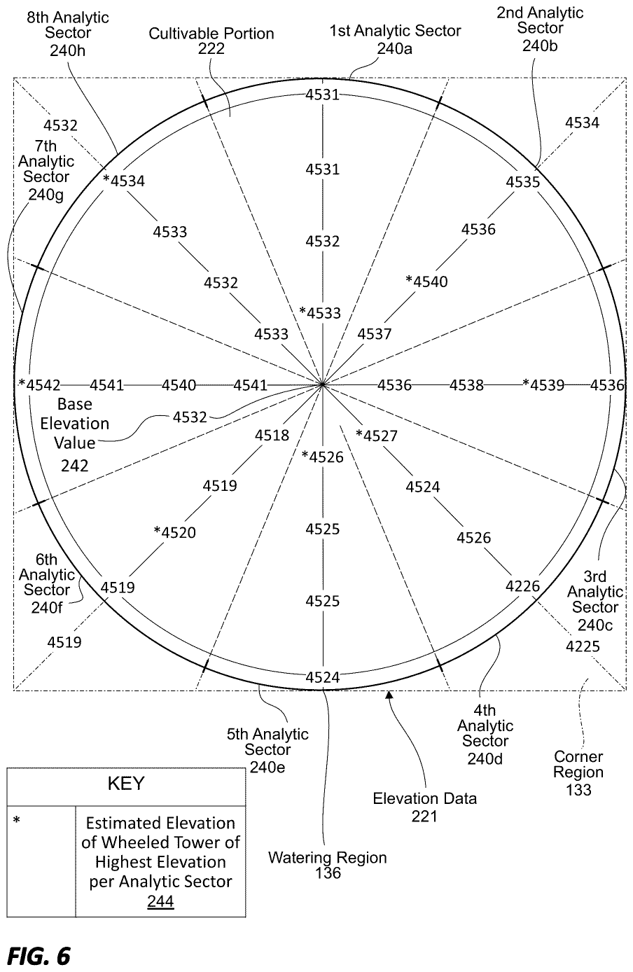

Speaking generally, FIGS. 1-5 describe systems and methods for formulating sectors and specifying sector-specific set point pressures, which may be based, for example, on user input and/or obtained elevation data. FIG. 6-11 described in greater detail formulating sectors and specifying sector-specific set point pressures utilizing obtained elevation data.

### Description of FIG. 1

FIG. 1 is a diagram illustrating one embodiment of the center pivot irrigation system 120. A water source 102 may be used to provide water to the center pivot irrigation system 120. A pump 100 provides pressurized water 116 via a conduit 106 to two center pivots 122a-b (i.e., watering regions 136a-b of a center pivot irrigation system 120).

A variable frequency drive 104 controls the speed of the pump 100. For example, the variable frequency drive may have a set point pressure 105 of 40 psi (pounds per square inch). In this example, the variable frequency drive 104 would alter the speed of the pump 100 to stay as close as possible to 40 psi.

A controller 110 may utilize set-point logic 112a-b to control the variable frequency drive 104. The set-point logic 112a-b may be stored at one or more locations, such as at the controller 110 or at the pivot center 124a-b of each center pivot 122a-b. The set-point logic 112a-b may comprise hardware and/or software for altering the set point pressure 105 of the variable frequency drive 104 based on the position of the pivoting span 130a-b, as will be set forth in detail below.

Each center pivot 124a-b comprises a pivot center 124a-b and a pivoting span 130a-b. The pivoting span 130a-b pivots around the pivot center 124a-b. Each pivot center 122a-b is in fluid communication with the conduit 106 and therefore receives the pressurized water 116 via the conduit 106. The pressurized water 116 is conveyed to each pivoting span 130a-b and provided to the sprinklers 128a-b on the pivoting span 130a-b. Wheeled towers 126a-b cause each pivoting span 130a-b to pivot about the pivot center 124a-b. It should be noted that the pressurized water 116 may include additives, such as fertilizers, herbicides, and pesticides.

A peripheral span position sensing system 132a-b may be positioned on each pivoting span 130a-b offset from the pivot center 124a-b, such as at the distal end 134a-b of the pivoting span 130a-b. The distal end 134a-b of the pivoting span 130a-b is the end of the span most remote from the pivot center 124a-b. In various embodiments, the peripheral span position sensing system 132a-b may comprise a GPS unit, which determines the GPS coordinates of the GPS unit and, therefore, can be utilized to determine the position of the pivoting span 130a-b relative to the pivot center 124a-b. A central span position sensing system 142a may be positioned at the pivot center 124a-b. In one embodiment, a central span position sensing system 142a may comprise a potentiometer, which may be configured to output a different voltage based on the position of the pivoting span 130a-b relative to the pivot center 124a-b.

Each center pivot 122a-b may include a peripheral span position sensing system 132a-b, a central span position sensing system 142a-b or both 132a-b, 142a-b. These systems 132a-b, 142a-b may be in wireless or wired electronic communication with various other components of the center pivot irrigation system 120, including the controller 110.

Watering regions 136a-b may be a circular region or square region (with the square region 136a-b shown in dot-dash broken lines) depending on whether end guns (not illustrated in the figures) are used, as illustrated in FIGS. 1, 2A, 3A, 4, 6 and 8. An end gun is a sprinkler disposed at or near a distal end 134a-b of each pivoting span 130a-b. When end guns are incorporated into the design and in use, the end guns provide water to corner regions 133a-b of a square watering region 136a-b.

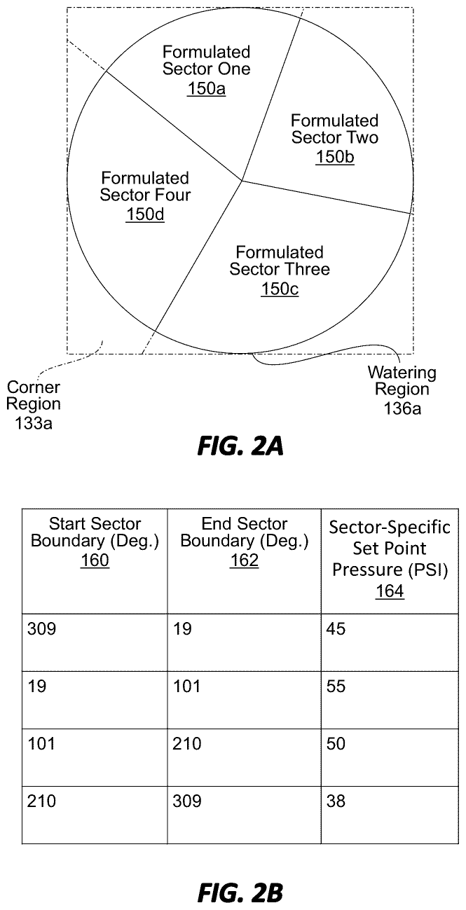

### Description of FIGS. 2A to 4

FIG. 2A is a diagram illustrating a watering region 136a of a center pivot irrigation system 120 having four formulated sectors 150a-d, and FIG. 2B is a table illustrating a start sector boundary 160, an end sector boundary 162, and a sector-specific set point pressure 164 for each of the formulated sectors 150a-d of FIG. 2A. Please note that the start sector boundary 160 and end sector boundary 162 are specified in degrees with the 0° position being the vertical (or north) position extending from a center of the watering region 136a. Therefore, as illustrated, formulated sector one 150a begins at 309° and ends at 19°. The sector-specific set point pressure 164 for formulated sector one 150a is 45 psi. Therefore, in accordance with the illustrated example, when a pivoting span 130a reaches the 309° position (the start sector boundary 160 for formulated sector one 150a), the set point pressure 105 for the variable frequency drive 104 will be changed to 45 psi, and, when the pivoting span 130a reaches the 19° position, the set point pressure 105 will be changed to the pertinent sector-specific set point pressure 164 (namely, 55 psi) and so forth. Of course, the foregoing is only one illustrative approach, and different approaches are possible within the scope of the disclosed subject matter, such as specifying the start sector boundary 160 and end sector boundary 162 in radians or having a different start position (e.g., 0° position). In addition, the example described in connection with FIGS. 2A-2B may involve the pivoting span 130a (illustrated in FIG. 1) rotating in a clockwise direction. If the pivoting span 130a rotated in a counterclockwise direction, each start sector boundary 160 and end sector boundary 162 would be swapped.

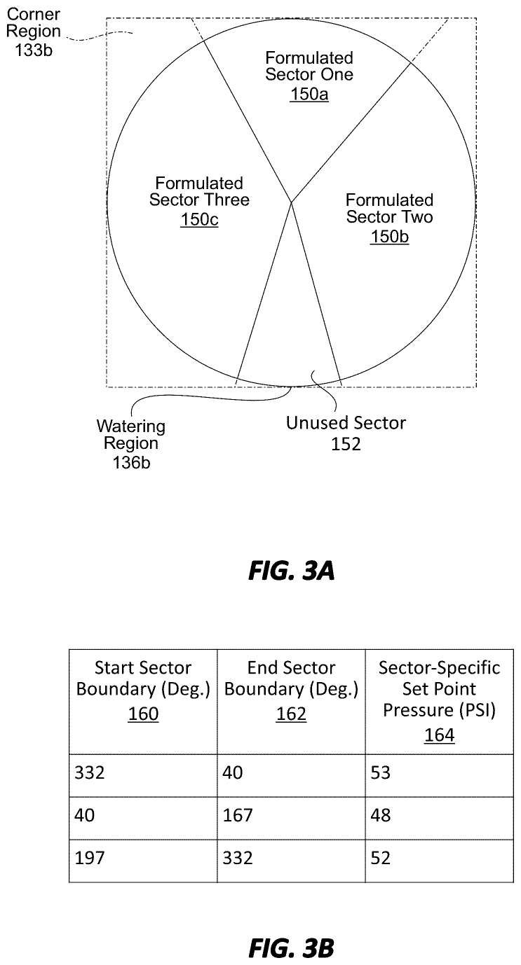

FIG. 3A is a diagram illustrating a watering region 136b of a center pivot irrigation system 120 having three formulated sectors 150a-c, and FIG. 3B is a table illustrating a start sector boundary 160, an end sector boundary 162, and a sector-specific set point pressure 164 for each of the formulated sectors 150a-c of FIG. 3A. FIGS. 3A-3B are similar to 2A-2B with the exception that an unused sector 152 is illustrated in FIG. 3A-3B. The unused sector 152 may refer to a portion of the watering region 136b that cannot be cultivated, such as a rock outcropping or a region in which a building is situated.

Therefore, as illustrated, again by way of example only, when the pivoting span 130b reaches the end sector boundary 162 of formulated sector two 150b, the pivoting span 130b could reverse directions to a counterclockwise direction (remaining at 48 psi) and, therefore, the start sector boundaries 160 and end sector boundaries 162 would be swapped for each of formulated sector one 150a, formulated sector two 150b, and formulated sector three 150c. In this scenario, when the pivoting span 130b (rotating in a counterclockwise direction) reaches the 40° position, the set point pressure 105 would be changed to the sector-specific set point pressure 164 (namely, 53 psi) for formulated sector one 150a and so forth.

Referring briefly once again to FIG. 1, in various embodiments, two different sector-specific set point pressures 164 may be specified at the same time because the pump 100 provides pressurized water 116 simultaneously to two different watering regions 136a-b (i.e., two different center pivots 122a-b). In such a scenario, the controller 110 may adopt the highest, lowest, or the average of the specified multiple sector-specific set point pressures as the set point pressure 105 for the variable frequency drive 104.

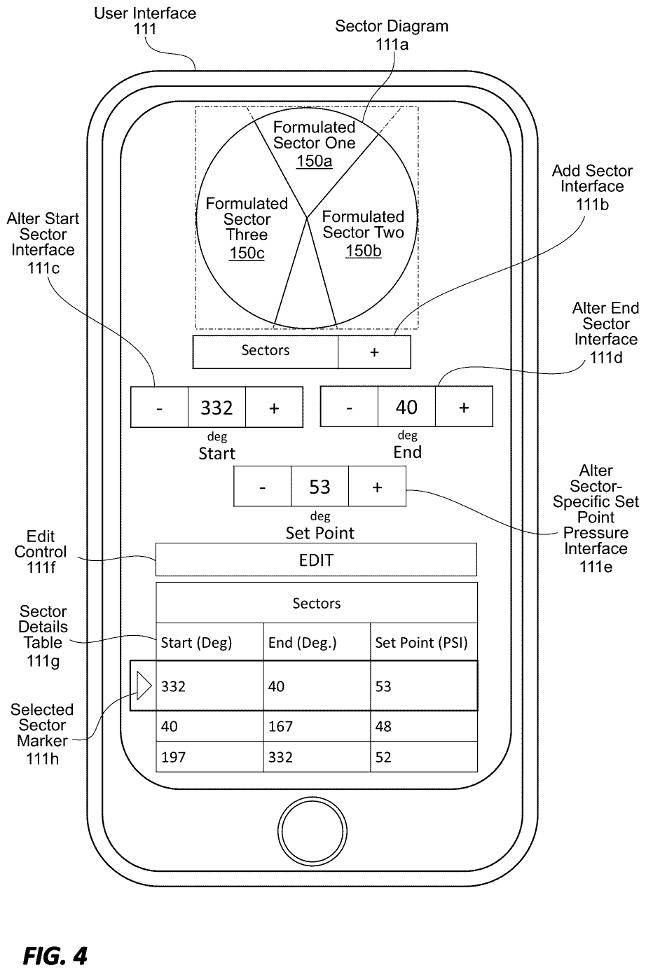

FIG. 4 illustrates a user interface 111 for specifying start sector boundaries 160, end sector boundaries 162, and sector-specific set point pressures 164. The user interface 111 may comprise a sector diagram 11la illustrating each of the formulated sectors 150a-c. The user interface 111 may also include an add sector interface 111b for adding more formulated sectors 150a-c. The user interface 111 may also comprise an alter start sector interface 111c, an alter end sector interface 111d, and an alter sector-specific set point pressure interface 11le for inputting a numeric value of the start sector boundary 160, the end sector boundary 162, or sector-specific set point pressure 164 for a specified formulated sector 150a-c, which may also be altered or specified utilizing the plus and minus keys on each of these interfaces 111c-d. The formulated sector 150a at issue may be identified with the selected sector marker 111h. The information related to each of the sectors 150a-c may be shown in a sector details table 111g. An edit control 111f may be activated to perform other functions in connection with the selected formulated sector 150a-c, such as deleting a selected sector 150a-c.

If an end gun (not illustrated in the figures) is used, the watering region 136a-b will be square (with the square watering region 136a-b being shown in dot-dash broken lines) and, therefore, the formulated sectors 150a-d will extend into the corner regions 133a-b of a square watering region 136a-b. The extensions of the formulated sectors 150a-d into the corner regions 133a-b are also illustrated in dot-dash broken lines.

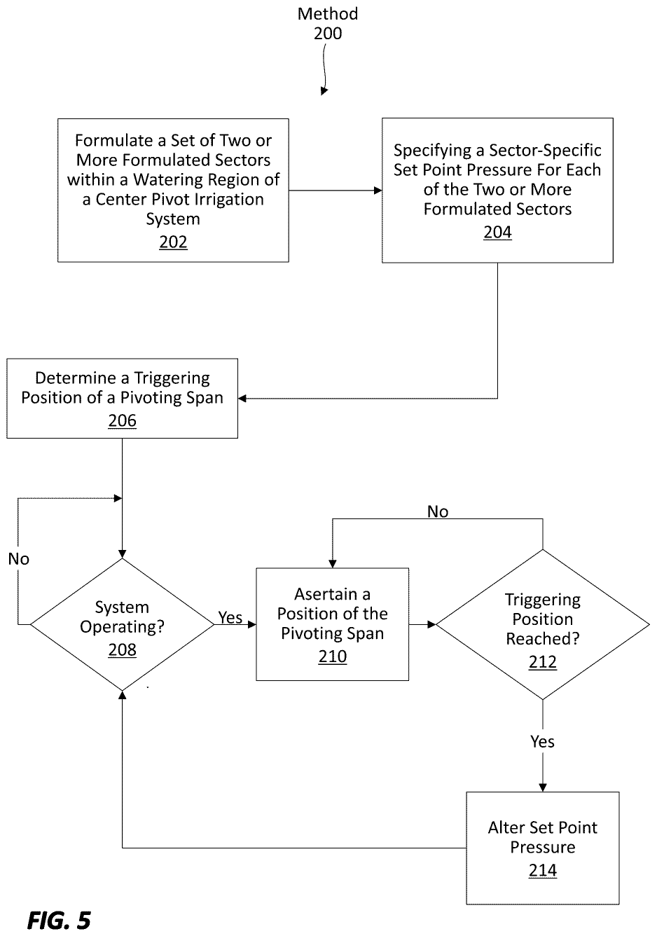

### Description of FIG. 5

FIG. 5 is a flow diagram illustrating a method 200 of formulating sectors 150a-d and specifying sector-specific set point pressures 164 and operating a center pivot irrigation system 120 in accordance with the formulated sectors 150a-d and the specified sector-specific set point pressures 164.

A set of two or more sectors are formulated 202 within a watering region 136a-b of a center pivot irrigation system 120. Each formulated sector 150a-d may comprise a start sector boundary 160 and an end sector boundary 162. Each sector 150a-d may be formulated based on user input utilizing a user interface, such as the illustrative user interface 111 presented in FIG. 4, or utilizing automated methods and systems that are, for example, subject to review and approval by an end-user. As an example of such automated systems and methods, the sectors 150a-d may be formulated utilizing elevation data, as will be explained in connection with FIGS. 6-11. In the scenario, when sectors 150a-d are formulated using elevation data, a user interface may also, in certain embodiments, be presented to allow the user to review and modify the formulated sectors 150a-d utilizing elevation data.

A sector-specific set point pressure 164 may be specified 204 for each of the two or more formulated sectors 150a-d. The sector-specific set point pressure 164 may be specified based on user input provided via a user interface (e.g., the user interface 111 presented in FIG. 4) or alternatively, using automated methods (e.g., based on elevation data, as will be explained below).

A triggering position of a pivoting span 130a-b may be determined 206 for each of the one or more formulated sectors 150a-d. In various embodiments, the triggering position may, for example, be a start sector boundary 160 or an end sector boundary 162 depending on the direction of travel of the pivoting span 130a-b. Alternatively, the triggering position may a position slightly before a start sector boundary 160 or an end sector boundary 162 depending on the direction and speed of travel of the pivoting span 130a-b in order to transition the sector-specific set point pressure 164 at a desired position (i.e., because there may be a delay in achieving the set point pressure 105 and when the instruction to alter the set point pressure 105 is issued).

It is then determined whether the center pivot irrigation system is operating 208. If no, this check is periodically performed. If yes, the position of the pivoting span 130a-b is periodically ascertained 210.

It is then determined whether a triggering position has been reached 212. If no, the position of the pivoting span 130a-b is periodically ascertained 210.

If yes, the set point pressure 105 of the variable frequency drive 104 is altered 214 in accordance with the sector-specific set point pressure 164 associated with the triggering position for the pertinent formulated sector 150a-d.

### Description of FIG. 6 to 8

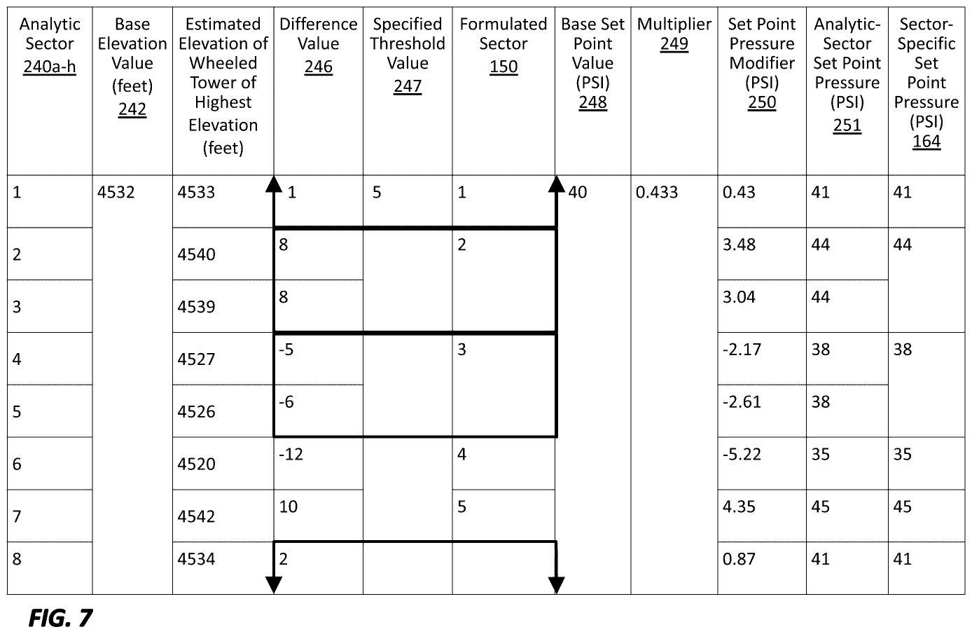

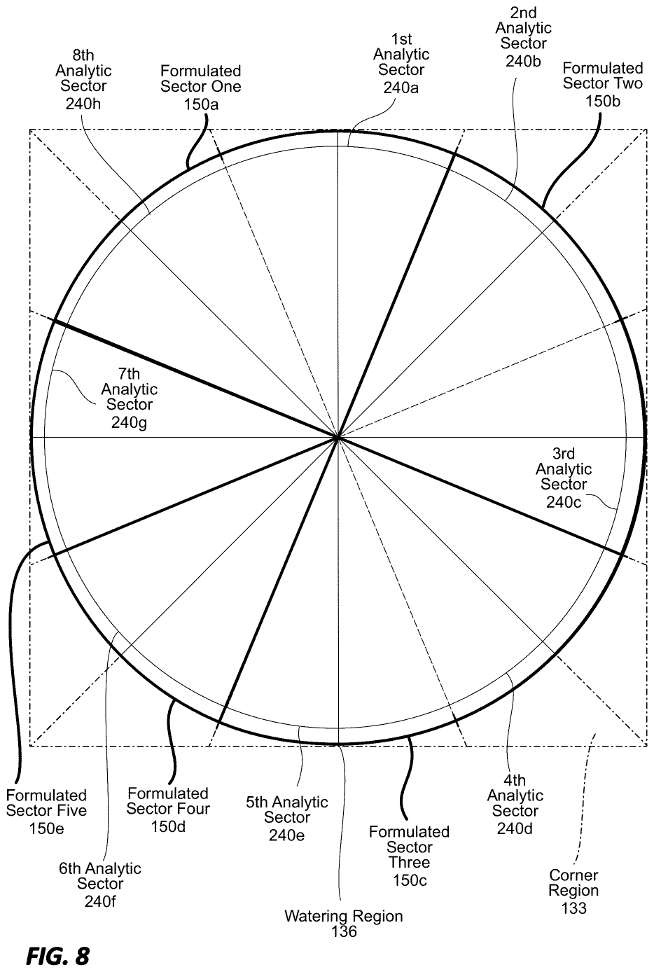

FIG. 6 is a diagram of obtained elevation data 221 at various points on watering region 136 of a center pivot irrigation system 120. FIG. 7 is a table illustrating methods of formulating sectors 150a-e and specifying sector-specific set point pressures 164 for each of the formulated sectors 150a-e based on the obtained elevation data 221 illustrated in FIG. 6. FIG. 8 is a diagram illustrating the formulated sectors 150a-e in accordance with the table of FIG. 7.

With reference to FIG. 6, elevation data 221 is obtained for a center pivot irrigation system 120. In FIG. 6, elevation data 221 is presented on a watering region 136 of a center pivot irrigation system 120. Elevation data 221 may be obtained in various ways, such as from a topographical map or from GPS units. Therefore, the watering region 136 may be divided into analytic sectors 240a-h, such as the eight analytic sectors 240a-h illustrated in FIG. 6. Of course, the number of analytic sectors 240a-h may be varied within the scope of the disclosed subject matter. For example, each degree of a watering region 136 may comprise an analytic sector, resulting in 360 analytic sectors. The analytic sectors 240a-h may be formulated based on the cultivable portion 222 (i.e., the portion of the watering region 136 that may be cultivated, such as excluding an unused sector 152, as illustrated in FIG. 3A). In various embodiments, elevation data 221 may be obtained based on the position of each of the wheeled towers 126a-b at regular intervals within the watering region 136 as the pivoting span 130a-b rotates around the pivot center 124a-. Therefore, in the example illustrated in FIG. 6, the pivoting span 130a-b would include four wheeled towers 126a-b as elevation data 221 is obtained in four radially aligned positions within each analytic sector 240a-h. The radially aligned positions at which the elevation data 221 is gathered bisects each analytic sector 240a-h into equal parts. However, this approach is merely for illustrative purposes, the elevation data 221 could be gathered from any portion of each analytic sector 240a-h and, in various embodiments, may be obtained at irregular or regular intervals within each analytic sector 240a-h. Also, it should be noted that the elevation data 221 could be obtained for other portions of the center pivot irrigation system 120, such as the pump 100, variable frequency drive 104, and/or controller 110.

Within each analytic sector 240a-h on FIG. 6, an estimated elevation of a wheeled tower of a highest elevation for each analytic sector 240a-h is identified and marked with an asterisk. A base elevation value 242 (such as 4532 feet) could be, for example, an estimated elevation of the pivot center 124a-b, as illustrated in FIG. 6, or an estimated elevation of a pump 100, variable frequency drive 104, or controller 110.

Referring now to FIG. 7, a numerical value assigned to each of the analytic sectors 240a-h is provided in column one of the illustrated table. In column two, a base elevation value 242 (discussed previously) is presented. In column three, an estimated elevation of a wheeled tower of highest elevation 244 within each analytic sector 240a-h is presented, referencing the illustration of FIG. 6. In column four, a difference value 246 is presented. Each difference value 246 is calculated by subtracting the estimated elevation of each wheeled tower of highest elevation 244 for each analytic sector 240a-h from the base elevation value 242. A positive difference value 246 indicates that the estimated elevation of a wheeled tower of highest elevation 244 is more elevated than the base elevation value 242. A negative difference value 246 indicates that the estimated elevation value of the wheeled tower of highest elevation 244 is of lower elevation and the base elevation value 242.

Referring to columns four to seven of FIG. 7 and also to FIG. 8, adjacent analytic sectors 240a-h having difference values 246 within a specified threshold value 247 (e.g., within a specified threshold value 247 of 5, as illustrated in FIG. 7 with the outcome of its application demonstrated in FIG. 8) are grouped together to formulate formulated sectors 150a-e. Of course, a specified threshold value 247 of 5 is only illustrative and other specified threshold values 247 could be used, such as 3 or 10. Therefore, in the provided example, the 1st analytic sector 240a and 8th analytic sector 240h are grouped together to formulate formulated sector one 150a because the difference values 246 are within the specified threshold value 247 of 5 (namely, difference values 246 of 1 and 2). The 2^{nd} analytic sector 240b and 3^{rd} analytic sector 240c are also grouped together to formulate formulated sector two 150b having difference values 246 within a specified threshold value 247 of 5 (namely, difference values 246 of 8 and 7). The 4^{th} analytic sector 240d and 5^{th} analytic sector 240e are grouped together to formulate formulated sector three 150c (based on difference values of −5 and −6). The 6^{th} analytic sector 240f and 7^{th} analytic sector 240g are grouped with no other analytic sectors 240a-h and, therefore, each result in their own formulated sectors 150d-e (namely, resulting in formulated sector four 150d and formulated sector five 150e).

The specified threshold value 247 may be specified in various ways, such as based on user input, a default value specified by the product manufacturer, or based on an analysis of the difference values 246, such as a standard deviation of all the difference values 246.

With reference to column seven, a base set point value 248 may be established for the center pivot irrigation system 120 or, alternatively, for each center pivot 122a-b (i.e., watering region 136). The base set point value 248 could be specified by a user, the system (a default value for system), or could be calculated based on elevation data 221 for the center pivot irrigation system 120 (e.g., an average of elevation data for a watering region 136 or for the entire center pivot irrigation system 120).

With respect to column nine, a set point pressure modifier 250 is calculated. In one embodiment, the set point pressure modifier 250 is calculated by multiplying 1/2.31 (a multiplier 249, which is approximately 0.433) by the difference value 246. The multiplier 249 specified above is based on the feet of head, which refers to the pressure differential and specific gravity of the liquid being pumped (e.g., water).

The set point pressure modifier 250 is rounded up to the next largest whole number (e.g., −2.61 is rounded up to −2 and 0.43 is rounded up to 1) and added to the base set point value 248 (namely, 40 psi) to formulate the analytic-sector set point pressure 251 set forth in column ten. In various embodiments, as illustrated in column ten and column eleven, the largest analytic-sector set point pressure 251 from the grouped analytic sectors 240a-h is utilized as the sector-specific set point pressure 164. Alternatively, an average or lowest of the analytic-sector set point pressure 251 of the grouped analytic sectors 240a-h may be utilized as the sector-specific set point pressure 164.

If an end gun (not illustrated in the figures) is used, the watering region 136 will be square (with the square watering region 136 being shown in dot-dash broken lines) and, therefore, the formulated sectors 150a-d and analytic sectors 240a-h will extend into the corner regions 133 of a square watering region 136. The extensions of the formulated sectors 150a-e and analytic sectors 240a-h into the corner regions 133 are also illustrated in dot-dash broken lines.

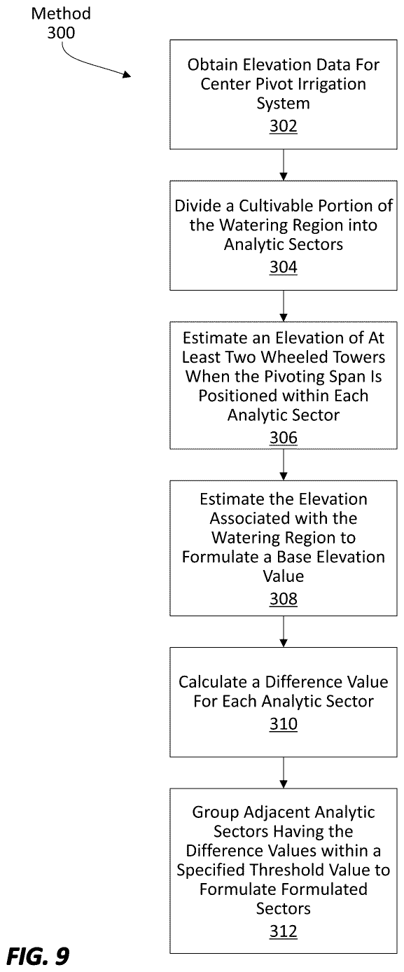

### Description of FIG. 9

FIG. 9 illustrates a method 300 of formulating formulated sectors 150a-e based on obtained elevation data 221. Elevation data 221 may be obtained 302, for example, from GPS units or from a topographical map. The elevation data 221 obtained may pertain to the entire center pivot irrigation system 120 or a watering region 136 of the center pivot irrigation system 120.

A cultivable portion 222 of a watering region 136 may be divided 304 into analytic sectors 240a-h. Analytic sectors 240a-h may be of the same size or of different sizes. Also, the number of analytic sectors 240a-h may be varied within the scope of the disclosed subject matter.

The elevation of at least two wheeled towers 126a-b (e.g., each pivoting span 126a-b or every other pivoting span 126a-b) when the pivoting span 130a-b is position within each analytic sector 240a-h is estimated 306. This estimation may take place employing GPS units positioned on two or more of the wheeled towers 126a-b. Alternatively, an offset value between wheeled towers 126a-b and a pivot center 124a-b and/or adjacent wheeled towers 126a-b may be obtained or input and estimates may be formulated by ascertaining a central, circumferential position (or other position) within each analytic sector 240a-h to estimate the elevation of each position within each analytic sector 240a-h utilizing elevation data 221 and/or associated satellite imagery. In alternative embodiments, a user may click on or tap locations on an electronic map of a user interface to identify locations of wheeled towers 126a-b for use in estimating the elevation of two or more wheeled towers 126a-b (i.e., elevation data 221 associated with the electronic map may be utilized to make the estimation). This estimation may also be formulated by a user specifying the number of analytic sectors 240a-h, thereby triggering the gathering of estimated locations of two or more wheeled towers 126a-b within each analytic sector 240a-h.

An elevation associated with the watering region 136 is estimated 308 to formulate a base elevation value 242. The base elevation value 242 may be estimated utilizing GPS coordinates (e.g., utilizing a GPS unit, input by a user, and/or derived from satellite imagery together with elevation data 221) of a pivot center 124a-b, a pump 100, a variable frequency drive 104, and/or a controller 110. Alternatively, the user may simply click or tap on a portion of an image or representation of the center pivot irrigation system 120 or a watering region 136 to derive/estimate the elevation for the identified location. In yet other alternatives embodiments, the base elevation value 242 may be estimated by averaging elevation data for a watering region 136.

A difference value 246 for each analytic sector 240a-h may be calculated 310 by subtracting a base elevation value 242 from an estimated elevation of a wheeled irrigation tower of highest elevation 244 within each analytic sector 240a-h, as explained previously. Alternatively, other estimated elevation values within each analytic sector 240a-h may be utilized to calculate the difference value 246, such as an average of estimated elevation values within each analytic sector 240a-h.

Adjacent analytic sectors 240a-h having difference values 246 within a specified threshold value 247 (e.g., 1/2.31) may be grouped 312 to formulate formulated sectors 150a-e, again as set forth above. The specified threshold value 247 could be, for example, 3, 5, 7 or 10 and may be specified based on user input, manufacturer-specified default values, and/or calculations, such as a standard deviation of all difference values.

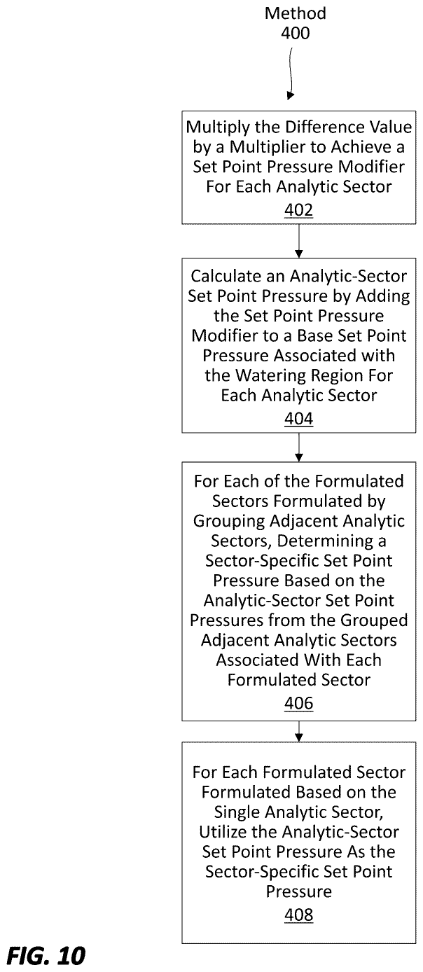

### Description of FIG. 10

A method 400 for specifying sector-specific set point pressures 164 is disclosed. A difference value 246 may be multiplied 402 by a multiplier 249 to achieve a set point pressure modifier 250, as discussed in connection with FIGS. 6-8. As noted, in various embodiments, the multiplier 249 may be 1/2.31. Calculation of the difference values 246 and variations thereof have been discussed previously.

An analytic-sector set point pressure 251 may be calculated 404 by adding the set point pressure modifier 250 to a base set point value 248 associated with the watering region 136 or center pivot irrigation system 120 at issue for each analytic sector 240a-h. As noted previously, the set point pressure modifier 250 may be rounded up to the next whole number before being added to the base set point value 248 to calculate the sector-specific set point pressure 164.

For each of the formulated sectors 150a-e formulated by grouping adjacent analytic sectors 240a-h, determine 406 a sector-specific set point pressure 164 based on the analytic-sector set point pressures 251 from the grouped adjacent analytic sectors 240a-h associated with each formulated sector 150a-e. In various embodiments, this determination may involve selecting a largest, an average, or a lowest of the pertinent analytic-sector set point pressures 251 for each formulated sector 150a-e. For each formulated sector 150a-e based on only a single analytic sector 240a-h, as illustrated in FIG. 7, the analytic set point pressure 251 may be utilized 408 as the sector-specific set point pressure 164, as illustrated in connection with the 6^{th} analytic sector 240f and 7^{th} analytic sector 240g of FIG. 7.

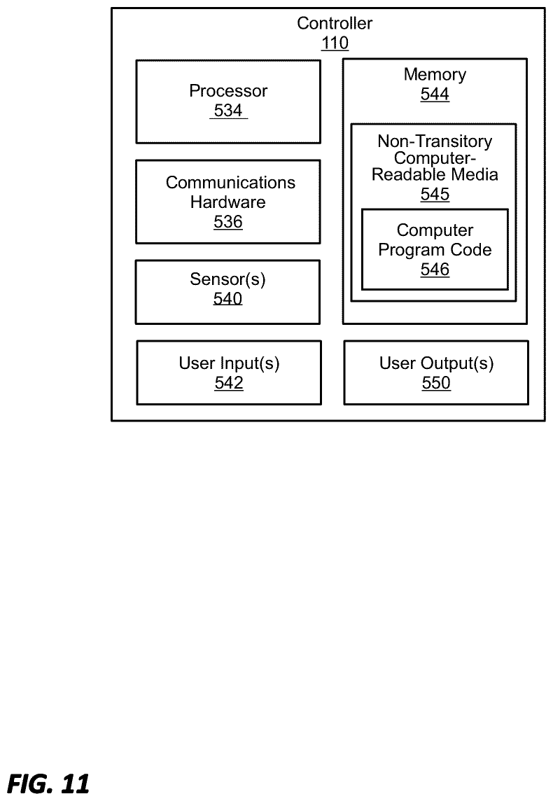

### Description of FIG. 11

The controller 110 illustrated in FIG. 11 (and also in FIG. 1) may be comprised of one or a plurality of different devices, such as a local device situated at or near a center pivot irrigation system 120 and/or a remote server. Thus, the components of the controller 110 may be distributed across multiple locations. The controller 110 may include a processor 534 that is designed to execute computer program code 546 encoded on non-transitory computer-readable media 545, which may comprise a portion of memory 544. The processor 534 may be one or more of any of a wide variety of types, including microprocessors with x86-based architecture or other architecture known in the art, application-specific integrated circuits (ASICs), field-programmable gate arrays (FPGA's), reduced instruction set computing (RISC) processor, including an advanced RISC (ARM) processor, and the like. The processor 534 may optionally include multiple processing elements, or “cores.” The processor 534 may include a “cache” that provides temporary storage of data incident to the operation of the processor 534.

The controller 110 may further include memory 544, which may be volatile memory (such as random-access memory (RAM)) and/or non-volatile memory (such as a solid-state drive or a hard disk drive). The memory 544a may include one or more memory modules (not shown), computer program code 546 (i.e., executable instructions) the non-transitory computer-readable media 545 of the memory 544, data referenced by such computer program code 546, and/or any other data that may beneficially be made readily accessible to the processor 534. The computer program code 546 and data stored in the memory 544, may include, for example, set-point logic 112a-b for establishing a set point pressure 105 of the variable frequency drive 104 in accordance with the systems and methods disclosed herein.

The controller 110 may further include network communications hardware 536 to facilitate wired and/or wireless communications between the controller 110 and any other device. The network communications hardware 536 may include Ethernet adapters, universal serial bus (USB) adapters, and/or any wireless hardware utilizing the protocols described, such as Wi-Fi adapters, ZigBee adapters, Z-Wave adapters, Bluetooth adapters, cellular network adapters, and/or the like. The network communications hardware 536 may enable communication, for example, with any component of the center pivot irrigation system 120, including the variable frequency drive 104, peripheral span position sensing system 132a-b, central span position sensing system 142a-b, or any other component of the pivot center 124a-b. The network communications hardware 536 could also include communications hardware for communicating with and opening and closing irrigation control valves, such as one or more relays or TRIACs (which refers to a triode for alternating current).

The controller 110 may also include any number of sensors 540 integrated with the controller 110 and/or sensors 540 that may be separate from, but in communication with the controller 110. Types of sensors 540 may include, but are not limited to: temperature sensors, precipitation sensors, soil moisture sensors, humidity sensors, wind sensors, flow rate sensors, and the like.

The controller 110 may additionally include one or more user inputs 542 configured to receive input from the user. The user inputs 542 may be integrated into the controller 110, or may be separate from the controller 110 and connected to the controller 110 via a wired or wireless connection. The user inputs 542 may include elements such as tablets, mobile phones, touch-responsive screens, buttons, keyboards, mice, track balls, track pads, styli, digitizers, digital cameras, microphones, and/or other user input devices known in the art.

The controller 110 may also include one or more user outputs 550 configured to provide output tactile, audio, or visual to the user. The user outputs 550 may be integrated into the controller 110 or may be separate from the controller 110 and connected to it via a wired or wireless connection. The user outputs 550 may include elements such as a mobile phone, tablet, display screen, speaker, vibration device, LED or other lights, and/or other output devices known in the art. In some embodiments, one or more of the user inputs 542 may be combined with one or more of the user outputs 550, as may be the case with a touch-responsive screen.

The controller 110 may include various other components not shown or described herein. Those of skill in the art will recognize, with the aid of the present disclosure, that any such components may be used to carry out the systems and methods disclosed herein.

### Conclusion

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods, systems and components of the matter disclosed herein without departing from the spirit and scope of the invention. For example, the number of analytic sectors 240a-h and the number of formulated sectors 150a-e presented in this disclosure are merely illustrative and the number of analytic sectors 240a-h and the number of formulated sectors 150a-e could be varied within the scope of the disclosed subject matter. The disclosed base elevation value 242, specified threshold value 247, base set point value 248, multiplier 249, start sector boundary 160, and end sector boundary 162 are also merely illustrative of the disclosed subject matter. In addition, the number of watering regions 136a-b (i.e., pivot centers 122a-b) within a center pivot irrigation system presented in FIG. 1 and discussed elsewhere are merely illustrative such that, for example, a center pivot irrigation system 120 could include only a single watering region or could include 3 or more watering regions. Also, various components illustrated as separate components may be integrated, such as the pump 100, variable frequency drive 104, and/or controller 110. Those skilled in the art will appreciate that the methods 200, 300, 400 disclose only illustrative steps, and additional steps may be added or the order of the steps may be varied within the scope of the disclosed subject matter. For example, with respect to step 306, locations other than locations of the wheeled towers 126a-b within each analytic sector 240a-h may also be utilized to provide estimated data. As an additional example, step 406 may be omitted or simply not implemented if the applicable analysis does not suggest grouping of any adjacent analytic sectors 240a-h. The values and analysis presented therein are presented in the Imperial system (e.g., US customary system), but should not be limited to this type of analysis and could be formulated based on the metric system. It should be noted that the specifically cited variations in alterations serve only as examples. Again, those skilled in the art may appreciate that the disclosed subject matter is only illustrative of the pertinent principles and components.

1. A system for controlling water pressure supplied within a center pivot irrigation system, the center pivot irrigation system including a pivot center, a pivoting span extending away from the pivot center, a pump for providing pressurized water to the pivot center, and a variable frequency drive that controls a speed of the pump based on a set point pressure, the pivoting span comprising a plurality of sprinklers for distributing water, the system comprising:
non-transitory computer readable media;
computer program code, encoded on the non-transitory computer readable media, configured to cause at least one processor of a set of one or more processors to perform the steps of:
formulating a set of two or more formulated sectors within a watering region of the center pivot irrigation system, each of the two or more formulated sectors comprising a start sector boundary and an end sector boundary;
specifying a sector-specific set point pressure for each of the two or more formulated sectors, a first sector-specific set point pressure comprising the sector-specific set point pressure specified for a first sector of the two or more formulated sectors;
determining a triggering position of the pivoting span for each of the two or more formulated sectors, a first triggering position comprising the triggering position determined for the first sector; and
when the center pivot irrigation system is in operation:
periodically ascertaining a position of the pivoting span; and
altering the set point pressure of the variable frequency drive to the first sector-specific set point pressure when the pivoting span reaches the first triggering position.

2. The system of claim 1, wherein determining the triggering position of the pivoting span for each of the two or more formulated sectors comprises estimating GPS coordinates of a GPS unit disposed on the pivoting span at the start sector boundary for each of the two or more formulated sectors, and wherein periodically ascertaining the position of the pivoting span comprises obtaining GPS coordinates from the GPS unit disposed on the pivoting span.

3. The system of claim 1, wherein determining the triggering position of the pivoting span for each of the two or more formulated sectors comprises ascertaining an angular position of the start sector boundary for each of the two or more formulated sectors, and wherein periodically ascertaining the position of the pivoting span is performed by a central span position sensing system at the pivot center.

4. The system of claim 3, wherein the central span position sensing system at the pivot center comprises a potentiometer.

5. The system of claim 1, further comprising presenting a user interface, wherein formulating the set of two or more formulated sectors within the watering region and specifying the sector-specific set point pressure for each of the two or more formulated sectors are performed in response to user input received at the user interface.

6. The system of claim 1, wherein formulating the set of two or more formulated sectors within the watering region of the center pivot irrigation system comprises:
obtaining elevation data for the center pivot irrigation system;
dividing a cultivable portion of the watering region into analytic sectors;
estimating an elevation of at least two wheeled towers of the pivoting span using the elevation data when the pivoting span is positioned within each analytic sector;
estimating the elevation associated with the watering region using the elevation data to formulate a base elevation value;
for each analytic sector, calculating a difference value by subtracting the base elevation value from the estimated elevation of a wheeled tower of highest elevation within each analytic sector; and
grouping adjacent analytic sectors having the difference values within a specified threshold value, wherein each set of one or more grouped analytic sectors comprises one of the formulated sectors of the set of two or more formulated sectors.

7. The system of claim 6, wherein specifying the sector-specific set point pressure comprises:
for each analytic sector:
multiplying the difference value by a multiplier to achieve a set point pressure modifier; and
calculating an analytic-sector set point pressure by adding the set point pressure modifier to a base set point value associated with the watering region;
for each of the formulated sectors formulated by grouping adjacent analytic sectors, determining a sector-specific set point pressure based on the analytic-sector set point pressures from the grouped adjacent analytic sectors associated with the formulated sector.

8. The system of claim 1, wherein the system comprises at least a server and a local device.

9. A method for controlling water pressure supplied within a center pivot irrigation system, the center pivot irrigation system including a pivot center, a pivoting span extending away from the pivot center, a pump for providing pressurized water to the pivot center, and a variable frequency drive that controls a speed of the pump based on a set point pressure, the pivoting span comprising a plurality of sprinklers for distributing water, the method comprising:
formulating, utilizing at least one processor of a set of one or more processors, a set of two or more formulated sectors within a watering region of the center pivot irrigation system, each of the two or more formulated sectors comprising a start sector boundary and an end sector boundary;
specifying, utilizing at least one processor of the set of one or more processors, a sector-specific set point pressure for each of the two or more formulated sectors, a first sector-specific set point pressure comprising the sector-specific set point pressure specified for a first sector of the two or more formulated sectors;
determining, utilizing at least one processor of the set of one or more processors, a triggering position of the pivoting span for each of the two or more formulated sectors, a first triggering position comprising the triggering position determined for the first sector; and
when the center pivot irrigation system is in operation:
periodically ascertaining, utilizing at least one processor of the set of one or more processors, a position of the pivoting span; and
altering, utilizing at least one processor of the set of one or more processors, the set point pressure of the variable frequency drive to the first sector-specific set point pressure when the pivoting span reaches the first triggering position.

10. The method of claim 9, wherein determining the triggering position of the pivoting span for each of the two or more formulated sectors comprises estimating GPS coordinates of a GPS unit disposed on the pivoting span at the start sector boundary for each of the two or more formulated sectors, and wherein periodically ascertaining the position of the pivoting span comprises obtaining GPS coordinates from the GPS unit disposed on the pivoting span.

11. The method of claim 9, wherein determining the triggering position of the pivoting span for each of the two or more formulated sectors comprises ascertaining an angular position of the start sector boundary for each of the two or more formulated sectors, and wherein periodically ascertaining the position of the pivoting span is performed by a central span position sensing system at the pivot center.

12. The method of claim 9, further comprising presenting a user interface, wherein formulating the set of two or more formulated sectors within the watering region and specifying the sector-specific set point pressure for each of the two or more formulated sectors are performed in response to user input received at the user interface.

13. The method of claim 9, wherein formulating the set of two or more formulated sectors within the watering region of the center pivot irrigation system comprises:
obtaining elevation data for the center pivot irrigation system;
dividing a cultivable portion of the watering region into analytic sectors;
estimating an elevation of at least two wheeled towers of the pivoting span using the elevation data when the pivoting span within each analytic sector;
estimating the elevation associated with the watering region using the elevation data to formulate a base elevation value;
for each analytic sector, calculating a difference value by subtracting the base elevation value from the estimated elevation of a wheeled tower of highest elevation within each analytic sector; and
grouping adjacent analytic sectors having the difference values within a specified threshold value, wherein each set of one or more grouped analytic sectors comprises one of the formulated sectors of the set of two or more formulated sectors.

14. The method of claim 13, wherein specifying the sector-specific set point pressure comprises:
for each analytic sector:
multiplying the difference value by a multiplier to achieve a set point pressure modifier; and
calculating an analytic-sector set point pressure by adding the set point pressure modifier to a base set point value associated with the watering region;
for each of the formulated sectors formulated by grouping adjacent analytic sectors, determining a sector-specific set point pressure based on the analytic-sector set point pressures from the grouped adjacent analytic sectors associated with the formulated sector.

15. A computer program product for controlling water pressure supplied within a center pivot irrigation system, the center pivot irrigation system including a pivot center, a pivoting span extending away from the pivot center, a pump for providing pressurized water to the pivot center, and a variable frequency drive that controls a speed of the pump based on a set point pressure, the pivoting span comprising a plurality of sprinklers for distributing water, the computer program product comprising:
non-transitory computer readable media; and
computer program code, encoded on the non-transitory computer readable media, configured to cause at least one processor of a set of one or more processors to perform the steps of:
formulating a set of two or more formulated sectors within a watering region of the center pivot irrigation system, each of the two or more formulated sectors comprising a start sector boundary and an end sector boundary;
specifying a sector-specific set point pressure for each of the two or more formulated sectors, a first sector-specific set point pressure comprising the sector-specific set point pressure specified for a first sector of the two or more formulated sectors;
determining a triggering position of the pivoting span for each of the two or more formulated sectors, a first triggering position comprising the triggering position determined for the first sector; and
when the center pivot irrigation system is in operation:
periodically ascertaining a position of the pivoting span; and
altering the set point pressure of the variable frequency drive to the first sector-specific set point pressure when the pivoting span reaches the first triggering position.

16. The computer program code of claim 15, wherein determining the triggering position of the pivoting span for each of the two or more formulated sectors comprises estimating GPS coordinates of a GPS unit disposed on the pivoting span at the start sector boundary for each of the two or more formulated sectors, and wherein periodically ascertaining the position of the pivoting span comprises obtaining GPS coordinates from the GPS unit disposed on the pivoting span.

17. The computer program code of claim 15, wherein determining the triggering position of the pivoting span for each of the two or more formulated sectors comprises ascertaining an angular position of the start sector boundary for each of the two or more formulated sectors, and wherein periodically ascertaining the position of the pivoting span is performed by a central span position sensing system at the pivot center.

18. The computer program code of claim 15, wherein formulating the set of two or more formulated sectors within the watering region of the center pivot irrigation system comprises:
obtaining elevation data for the center pivot irrigation system;
dividing a cultivable portion of the watering region into analytic sectors;
estimating an elevation of at least two wheeled towers of the pivoting span using the elevation data when the pivoting span is positioned within each analytic sector;
estimating the elevation associated with the watering region using the elevation data to formulate a base elevation value;
for each analytic sector, calculating a difference value by subtracting the base elevation value from the estimated elevation of a wheeled tower of highest elevation within each analytic sector; and
grouping adjacent analytic sectors having the difference values within a specified threshold value, wherein each set of one or more grouped analytic sectors comprises one of the formulated sectors of the set of two or more formulated sectors.

19. The computer program code of claim 18, wherein specifying the sector-specific set point pressure comprises:
for each analytic sector:
multiplying the difference value by a multiplier to achieve a set point pressure modifier; and
calculating an analytic-sector set point pressure by adding the set point pressure modifier to a base set point value associated with the watering region;
for each of the formulated sectors formulated by grouping adjacent analytic sectors, determining a sector-specific set point pressure based on the analytic-sector set point pressures from the grouped adjacent analytic sectors associated with the formulated sector.
